(19) United States
(12) Patent Application Publication
(10) Pub. No.: US 2023/0379460 A1
(43) Pub. Date: Nov. 23, 2023

(54) FILTER STRENGTH CONTROL FOR ADAPTIVE LOOP FILTERING

(71) Applicant: Telefonaktiebolaget LM Ericsson (publ), Stockholm (SE)

(72) Inventors: Kenneth ANDERSSON, Gävle (SE); Jacob STRÖM, Stockholm (SE)

(73) Assignee: Telefonaktiebolaget LM Ericsson (publ), Stockholm (SE)

(21) Appl. No.: 18/245,307

(22) PCT Filed: Sep. 23, 2021
(86) PCT No.: PCT/SE2021/050928

§ 371 Date: Mar. 14, 2023

Related U.S. Application Data
(60) Provisional application No. 63/084,975, filed on Sep. 29, 2020.

(51) Int. Cl. H04N 19/117; H04N 19/147; H04N 19/136; H04N 19/30; H04N 19/65; H04N 19/124; H04N 19/103

(52) U.S. Cl. CPC H04N 19/117; H04N 19/147; H04N 19/136; H04N 19/30; H04N 19/65; H04N 19/124; H04N 19/103

(57) ABSTRACT

There are provided mechanisms for encoding an image. The method comprises determining adaptive loop filter, ALF, coefficient values. The method comprises determining a scaling factor. The method further comprises generating scaled ALF coefficient values by applying the scaling factor to one or more of the ALF coefficient values. The method comprises providing the scaled ALF coefficient values to a decoder, wherein providing the scaled ALF coefficient values to the decoder comprises encoding the scaled ALF coefficient values in a bitstream and conveying the bitstream over a network. The determined ALF coefficient values reduce an error between reconstructed image components and original image components and the determined scaling factor improves subjective performance for image to be encoded.

### TECHNICAL FIELD

This disclosure relates to video encoding and/or decoding of an image or a video sequence.

### BACKGROUND

A video sequence consists of several images (also referred to herein as “pictures”). When viewed on a screen, the image consists of pixels, each pixel having a red, green and blue (RGB) value. However, when encoding and decoding a video sequence, the image is often not represented using RGB values but typically using another color space, including but not limited to YCbCr, IC_{T}C_{P}, non-constant-luminance YCbCr, and constant luminance YCbCr. If we take the example of YCbCr, which is currently the most used representation, it is made up of three components: luma (Y), which roughly represents luminance, and chroma (Cb, and Cr), both of which represents chrominance. It is often the case that Y is of full resolution, whereas the two other components, Cb and Cr, are of a smaller resolution. A typical example is a high definition (HD) video sequence containing 1920×1080 RGB pixels, which is often represented with a 1920×1080-resolution Y component, a 960×540 Cb component and a 960×540 Cr component. The elements in the components are called samples. In the example given above, there are therefore 1920×1080 samples in the Y component, and, hence, there is a direct relationship between samples and pixels. Therefore, in this document, the term pixels and samples is sometimes used interchangeably. For the Cb and Cr components, there is no direct relationship between samples and pixels; a single Cb sample typically influences several pixels.

In the draft for the Versatile Video Coding (VVC) standard, which is developed by the Joint Video Experts Team (JVET), the decoding of an image can be thought of as carried out in two stages: (1) prediction decoding and (2) loop filtering. In the prediction decoding stage, the samples of the components (Y, Cb, and Cr) are partitioned into rectangular blocks. As an example, one block may be of size 4×8 samples, whereas another block may be of size 64×64 samples. The decoder obtains instructions for how to do a prediction for each block, for instance to copy samples from a previously decoded image (an example of temporal prediction), to copy samples from already decoded parts of the current image (an example of intra prediction), or to perform a combination thereof. To improve this prediction, the decoder may obtain a residual, often encoded using transform coding such as discrete sine transform (DST) or the discrete cosine transform (DCT). This residual is added to the prediction, and the decoder can proceed to decode the subsequent block.

The output from the prediction decoding stage is the three components: Y, Cb, and Cr. However, it is possible to further improve the fidelity of these components, and this is done in the loop filtering stage. The loop filtering stage in the current draft of VVC consists of three sub-stages: (1) a deblocking filter stage, (2) a sample adaptive offset filter (SAO) sub-stage, and (3) an adaptive loop filter (ALF) sub-stage.

In the deblocking filter sub-stage, the decoder changes Y, Cb, and Cr by smoothing edges near block boundaries when certain conditions are met. This increases perceptual quality (subjective quality) since the human visual system is very good at detecting regular edges such as block artifacts along block boundaries. In the SAO sub-stage, the decoder adds or subtracts a signaled value to samples that meet certain conditions, such as being in a certain value range (band offset SAO) or having a specific neighborhood (edge offset SAO). This can reduce ringing noise since such noise often aggregates in certain value ranges or in specific neighborhoods (e.g., in local maxima). In this document, the reconstructed image components that are the result of this stage are denoted as Y_{SAO}, Cb_{SAO}, and Cr_{SAO}.

Embodiments of this disclosure relate to the third sub-stage (i.e., the ALF stage). The basic idea behind adaptive loop filtering is that the fidelity of the image components Y_{SAO}, Cb_{SAO}, and Cr_{SAO} can often be improved by filtering the image using a linear filter that is signaled from the encoder to the decoder. As an example, by solving a least-squares problem, the encoder can determine what coefficient values a linear filter should have in order to most efficiently lower the error between the reconstructed image components so far, Y_{SAO}, Cb_{SAO}, and Cr_{SAO}, and the original image components Y_{org}, Cb_{org}, and Cr_{org}. These coefficient values (or simply “coefficients” for short) can then be signaled from the encoder to the decoder. The decoder reconstructs the image as described above to get Y_{SAO}, Cb_{SAO}, and Cr_{SAO}, obtains the filter coefficients from the bit stream, and then applies the filter to get the final output, which are denoted as Y_{ALF}, Cb_{ALF}, Cr_{ALF}.

In VVC, the ALF luma filter is more advanced than this. To start, it is observed that it is often advantageous to filter some samples with one set of coefficients, but avoid filtering other samples, or perhaps filter those other samples with another set of coefficients. To that end, VVC classifies every Y sample (i.e., every luma sample) into one of 25 classes. The class to which a sample belongs is decided for each 4×4 block based on the local neighborhood of that sample (8×8 neighborhood), specifically on the gradients of surrounding samples and the activity of surrounding samples. As can be seen from the VVC specification, four variables are computed to determine the characteristics of the local neighborhood of the current sample where filtH measures gradient horizontally, filtV measures gradients vertically, filtD0 measures gradients diagonally top left to bottom right, and filtD1 measures gradients diagonally top right to bottom left:

filtH[i][j]=Abs((recPicture[hₓ₄₊ᵢ][v_{y4+j}]<<1)−recPicture[hₓ₄₊ᵢ₋₁][v_{y4+j}]−recPicture[hₓ₄₊ᵢ₊₁][v_{y4+j}]) (1471)

filtV[i][j]=Abs((recPicture[hₓ₄₊ᵢ][v_{y4+j}]<<1)−recPicture[hₓ₄₊ᵢ][v_{y4+j-1}]−recPicture[hₓ₄₊ᵢ][v_{y4+j+1}]) (1472)

filtD0[i][j]=Abs((recPicture[hₓ₄₊ᵢ][v_{y4+j}]<<1)−recPicture[h_{x4+i i-1}][v_{y4+j-1}]−recPicture[hₓ₄₊ᵢ₊₁][v_{y4+j+1}]) (1473)

filtD1[i][j]=Abs((recPicture[hₓ₄₊ᵢ][v_{y4+j}]<<1)−recPicture[hₓ₄₊ᵢ₊₁][v_{y4+j-1}]−recPicture[hₓ₄₊ᵢ₋₁][v_{y4+j+1}]) (1474)

Then, these variables are summed up in a local neighborhood around the current sample to get a more reliable estimate of the directionality of the neighborhood as follows, where sumH indicates the sum of filtH, sumV indicates the sum of filtV, sumD0 indicates the sum of filtD0, sumD1 indicates the sum of filtD1, and sumOfHV indicates the sum of sumH and sumV from VVC draft below:

sumH[x][y]=ΣᵢΣⱼfiltH[i][j], with i=−2 . . . 5, j=minY . . . maxY (1475)

sumV[x][y]=ΣᵢΣⱼfiltV[i][j], with i=−2 . . . 5, j=minY . . . maxY (1476)

sumD0[x][y]=ΣᵢΣⱼfiltD0[i][j], with i=−2 . . . 5, j=minY . . . maxY (1477)

sumD1[x][y]=ΣᵢΣⱼfiltD1[i][j], with i=−2 . . . 5, j=minY . . . maxY (1478)

sumOfHV[x][y]=sumH[x][y]+sumV[x][y] (1479)

Finally, based on these metrics, a classification is made to determine which set of filters filtIdx to use for the current sample and also a transposeIdx such that several directionalities can share the same filter coefficients, from VVC draft below:

The classification filter index array filtIdx and transpose index array transposeIdx are derived by the following steps:
1. The variables dir1[x][y], dir2[x][y] and dirS[x][y] with x, y=0 . . . CtbSizeY−1 are derived as follows:
   The variables hv1, hv0 and dirHV are derived as follows:
      If sumV[x>>2][y>>2] is greater than sumH[x>>2][y>>2], the following applies:

hv1=sumV[x>>2][y>>2] (1480)

hv0=sumH[x>>2][y>>2] (1481)

dirHV=1 (1482)
Otherwise, the following applies:

hv1=sumH[x>>2][y>>2] (1483)

hv0=sumV[x>>2][y>>2] (1484)

dirHV=3 (1485)
The variables d1, d0 and dirD are derived as follows:
   If sumD0[x>>2][y>>2] is greater than sumD1[x>>2][y>>2], the following applies:

d1=sumD0[x>>2][y>>2] (1486)

d0=sumD1[x>>2][y>>2] (1487)

dirD=0 (1488)
Otherwise, the following applies:

d1=sumD1[x>>2][y>>2] (1489)

d0=sumD0[x>>2][y>>2] (1490)

dirD=2 (1491)
The variables hvd1, hvd0, are derived as follows:

hvd1=(d1*hv0>hv1*d0)?d1:hv1 (1492)

hvd0=(d1*hv0>hv1*d0)?d0:hv0 (1493)
The variables dirS[x][y], dir1[x][y] and dir2[x][y] derived as follows:

dir1[x][y]=(d1*hv0>hv1*d0)?dirD:dirHV (1494)

dir2[x][y]=(d1*hv0>hv1*d0)?dirHV:dirD (1495)

dirS[x][y]=(hvd1*2>9*hvd0)?2:((hvd1>2*hvd0)?1:0) (1496)
2. The variable avgVar[x][y] with x, y=0 . . . CtbSizeY−1 is derived as follows:

varTab[ ]={0,1,2,2,2,2,2,3,3,3,3,3,3,3,3,4} (1497)

avgVar[x][y]=varTab[Clip3(0,15,(sumOfHV[x>>2][y>>2]*ac[x>>2][y>>2])>>(BitDepth−1))] (1498)
3. The classification filter index array filtIdx[x][y] and the transpose index array transposeIdx[x][y] with x=y=0 . . . CtbSizeY−1 are derived as follows:

transposeTable[ ]={0,1,0,2,2,3,1,3}

transposeIdx[x][y]=transposeTable[dir1[x][y]*2+(dir2[x][y]>>1)]

filtIdx[x][y]=avgVar[x][y]
When dirS[x][y] is not equal 0, filtIdx[x][y] is modified as follows:

filtIdx[x][y]+=(((dir1[x][y]&0x1)<<1)+dirS[x][y])*5 (1499)

From above it can be seen that filtIdx equal to 0 to 4 do not have any specific directional characteristics. A value of filterIdx greater than 4 corresponds to directionality of the samples, since this means that dirS is greater than 0. Studying the addition to filtIdx,

filtIdx[x][y]+=(((dir1[x][y]&0x1)<<1)+dirS[x][y])*5,

we see that if there is a diagonal directionality, i.e., if dir1 is either 0 or 2, the first term will be zero, and either 1*5 (if dirS=1) or 2*5 (if dirS=2) can be added. (If dirS=0, the addition will not be done.) Hence, all values of filterIdx from 5 to 14 correspond to a diagonal directionality of the samples. Likewise, if there is a horizontal or vertical directionality, i.e., if dir1 is either 1 or 3, then the first term (dir1 & 1)<<1 will become 2. Therefore, in this case, either (2+1)*5 (if dirS=1) or (2+2)*5 (if dirS=2) will be added resulting in values between 15 and 24. Hence, we have concluded that filtIdx indicates the directionality of the surrounding samples in the following way as described in Table 1:

The value filtIdx indicates directionality in the following way

| filtIdx range | Directionality |
|---|---|
| 0 . . . 4 | No directionality |
| 5 . . . 14 | Diagonal directionality (dir1 = 0 or 2) |
| 15 . . . 24 | Horizontal or vertical directionality (dir1 = 1 or 3) |

Where transposeIdx equal to 0 corresponds to no transpose of the filter coefficients, transposeIdx equal to 1 corresponds to mirroring the filter coefficients along the diagonal from top right to bottom left, transposeIdx equal to 2 corresponds to mirroring the filter coefficients along the vertical axis, and transposeIdx equal to 3 corresponds to rotating the filter coefficients 90 degrees.

This means that, when the filterIdx is between 15 and 24 and transposeIdx is equal to 3, the local structure around the current sample has a vertical directionality, and, when transposeIdx is equal to 0, the local structure around the current sample has a horizontal directionality.

It is possible for the encoder to signal one set of coefficients for each of the 25 classes. In VVC, the ALF coefficients are signaled in the adaptive parameter sets (APS) that then can be referred by an aps index that determines which of the defined sets to use to when decoding pictures. The decoder will then first decide which class a sample belongs to, and then select the appropriate set of coefficients to filter the sample. However, signaling 25 sets of coefficients can be costly. Hence the VVC standard also allows that only a few of the 25 classes are filtered using unique sets of coefficients. The remaining classes may reuse a set of coefficients used in another class, or it may be determined that it should not be filtered at all. For samples belonging to Cb or Cr, i.e., for chroma samples, no classification is used and the same set of coefficients is used for all samples.

Transmitting the filter coefficients is costly, and, therefore, the same coefficient value is used for two filter positions. For luma (samples in the Y-component), the coefficients are re-used in the way shown in FIG. 1. As shown in FIG. 1, each coefficient is used twice in the filter, and FIG. 1 shows the spatial neighborhood that the luma filter covers. That is, FIG. 1 shows the other sample values that are used to filter the value of the current sample (i.e., the sample value in the center of neighborhood) and its configuration with regards to filter coefficients for luma. It can be seen that the filter coverage is symmetric and covers up to 3 samples away from the center both horizontally and vertically.

Assume R(x,y) is the sample to be filtered, situated in the middle of the FIG. 1. Then samples R(x,y−1) (the sample exactly above) and the sample R(x,y+1) (the sample exactly below) will be treated with the same coefficient C6.

The filtered version of the reconstructed sample in position (x,y), which we will denote R_{F}(x,y), is calculated in the following way from VVC specification equation 1411 to 1426 and Table 43, where (x,y)=(hₓ,v_{y}) and C0=f[idx[0]], C1=f[idx[1]], C2=f[idx[2]], C3=f[idx[3]], C4=f[idx[4]], C5=f[idx[5]], C6=f[idx[6]], C7=f[idx[7]], C8=f[idx[8]], C9=f[idx[9]], C10=f[idx[10]] and C11=f[idx[11]]:
The array of luma filter coefficients f[j] and the array of luma clipping values c[j] corresponding to the filter specified by filtIdx[x][y] is derived as follows with j=0 . . . 11:
   If AlfCtbFiltSetIdxY[xCtb>>CtbLog2SizeY][yCtb>>CtbLog2SizeY] is less than 16, the following applies:

i=AlfCtbFiltSetIdxY[xCtb>>CtbLog2SizeY][yCtb>>CtbLog2SizeY] (1453)

f[j]=AlfFixFiltCoeff[AlfClassToFiltMap[i][filtIdx[x][y]][j] (1454)

c[j]=2BitDepth (1455)
Otherwise (AlfCtbFiltSetIdxY[xCtb>>CtbLog2SizeY][yCtb>>CtbLog2SizeY] is greater than or equal to 16, the following applies:

i=slice_alf_aps_id_luma[AlfCtbFiltSetIdxY[xCtb>>CtbLog2SizeY][yCtb>>CtbLog2SizeY]−16] (1456)

f[j]=AlfCoeff_{L}[i][filtIdx[x][y]][j] (1457)

c[j]=AlfClip_{L}[i][filtIdx[x][y]][j] (1458)
The luma filter coefficients and clipping values index idx are derived depending on transposeIdx[x][y] as follows:
   If transposeIndex[x][y] is equal to 1, the following applies:

idx[ ]={9,4,10,8,1,5,11,7,3,0,2,6} (1459)
Otherwise, if transposeIndex[x][y] is equal to 2, the following applies:

idx[ ]={0,3,2,1,8,7,6,5,4,9,10,11} (1460)
Otherwise, if transposeIndex[x][y] is equal to 3, the following applies:

idx[ ]={9,8,10,4,3,7,11,5,1,0,2,6} (1461)
Otherwise, the following applies:

idx[ ]={0,1,2,3,4,5,6,7,8,9,10,11} (1462)
The locations (hₓ₊ᵢ, v_{y+j}) for each of the corresponding luma samples (x, y) inside the given array recPicture of luma samples with i, j=−3 . . . 3 are derived as follows:

hₓ₊ᵢ=Clip3(0,pic_width_in_luma_samples−1,xCtb+x+i) (1463)

v_{y+j}=Clip3(0,pic_height_in_luma_samples−1,yCtb+y+j) (1464)
The variables clipLeftPos, clipRightPos, clipTopPos, clipBottomPos, clipTopLeftFlag and clipBotRightFlag are derived by invoking the ALF boundary position derivation process as specified in clause 8.8.5.5 with (xCtb, yCtb) and (x, y) as inputs.
The variables hₓ₊ᵢ and v_{y+j} are modified by invoking the ALF sample padding process as specified in clause 8.8.5.6 with (xCtb, yCtb), (hₓ₊ᵢ, v_{y+j}), 0, clipLeftPos, clipRightPos, clipTopPos, clipBottomPos, clipTopLeftFlag and clipBotRightFlag as input.
The variable applyAlfLineBufBoundary is derived as follows:
   If the bottom boundary of the current coding tree block is the bottom boundary of current picture and pic_height_in_luma_samples−yCtb<=CtbSizeY−4, applyAlfLineBufBoundary is set equal to 0:
   Otherwise, applyAlfLineBufBoundary is set equal to 1.
The vertical sample position offsets y1, y2, y3 and the variable alfShiftY are specified in Table 45 according to the vertical luma sample position y and applyAlfLineBufBoundary.
The variable curr is derived as follows:

curr=recPicture[hₓ][v_{y}] (1465)
The variable sum is derived as follows:

sum=f[idx[0]]*(Clip3(—c[idx[0]], c[idx[0]], recPicture[hₓ][v_{y+y3}]−curr)+Clip3(—c[idx[0]], c[idx[0]], recPicture[hₓ][v_{y-y3}]−curr))+f[idx[1]]*(Clip3(—c[idx[1]], c[idx[1]], recPicture[hₓ₊₁][v_{y+y2}]−curr)+Clip3(—c[idx[1]], c[idx[1]], recPicture[hₓ₋₁][v_{y-y2}]−curr))+f[idx[2]]*(Clip3(—c[idx[2]], c[idx[2]], recPicture[hₓ][v_{y+y2}]−curr)+Clip3(—c[idx[2]], c[idx[2]], recPicture[hₓ][v_{y-y2}]−curr))+f[idx[3]]*(Clip3(—c[idx[3]], c[idx[3]], recPicture[hₓ₋₁][v_{y+y2}]−curr)+Clip3(—c[idx[3]], c[idx[3]], recPicture[hₓ₊₁][v_{y-y2}]−curr))+f[idx[4]]*(Clip3(—c[idx[4]], c[idx[4]], recPicture[hₓ₊₂][v_{y+y1}]−curr)+Clip3(—c[idx[4]], c[idx[4]], recPicture[hₓ₋₂][v_{y-y1}]−curr))+f[idx[5]]*(Clip3(—c[idx[5]], c[idx[5]], recPicture[hₓ₊₁][v_{y+y1}]−curr)+Clip3(—c[idx[5]], c[idx[5]], recPicture[hₓ₋₁][v_{y-y1}]−curr))+f[idx[6]]*(Clip3(—c[idx[6]], c[idx[6]], recPicture[hₓ][v_{y+y1}]−curr)+Clip3(—c[idx[6]], c[idx[6]], recPicture[hₓ][v_{y-y1}]−curr))+f[idx[7]]*(Clip3(—c[idx[7]], c[idx[7]], recPicture[hₓ₋₁][v_{y+y1}]−curr)+Clip3(—c[idx[7]], c[idx[7]], recPicture[hₓ₊₁][v_{y-y1}]−curr))+f[idx[8]]*(Clip3(—c[idx[8]], c[idx[8]], recPicture[hₓ₋₂][v_{y+y1}]−curr)+Clip3(—c[idx[8]], c[idx[8]],recPicture[hₓ₊₂][v_{y-y1}]−curr))+f[idx[9]]*(Clip3(—c[idx[9]],c[idx[9]],recPicture[hₓ₊₃][v_{y}]−curr)+Clip3(—c[idx[9]],c[idx[9]],recPicture[hₓ₋₃][v_{y}]−curr))+f[idx[10]]*(Clip3(—c[idx[10]],c[idx[10]],recPicture[hₓ₊₂][v_{y}]−curr)+Clip3(—c[idx[10]],c[idx[10]],recPicture[hₓ₋₂][v_{y}]−curr))+f[idx[11]]*(Clip3(—c[idx[11]],c[idx[11]],recPicture[hₓ₊₁][v_{y}]−curr)+Clip3(—c[idx[11]],c[idx[11]],recPicture[hₓ₋₁][v_{y}]−curr)) (1466)

sum=curr+((sum+64)>>alfShiftY) (1467)
The modified filtered reconstructed luma picture sample alfPicture_{L}[xCtb+x][yCtb+y] is derived as follows:

alfPicture_{L}[xCtb+x][yCtb+y]=Clip3(0,(1<<BitDepth)−1,sum) (1468)

TABLE 45
Specification of y1, y2, y3 and alfShiftY according to the vertical
luma sample position y and apply AlfLineBufBoundary

| Condition | alfShiftY | y1 | y2 | y3 |
|---|---|---|---|---|
| (y == CtbSizeY − 5 \|\| y == CtbSizeY − 4) && | 10 | 0 | 0 | 0 |
| ( apply AlfLineBufBoundary == 1) | | | | |
| (y == CtbSizeY − 6 \|\| y == CtbSizeY − 3) && | 7 | 1 | 1 | 1 |
| ( apply AlfLineBufBoundary == 1) | | | | |
| (y == CtbSizeY − 7 \|\| y == CtbSizeY − 2) && | 7 | 1 | 2 | 2 |
| ( apply AlfLineBufBoundary == 1) | | | | |
| Otherwise | 7 | 1 | 2 | 3 |

CtbSizeY is the vertical size of the CTU. CTU in VVC is typically 128×128. Here the Clip3(x,y,z) operation simply makes sure that the magnitude of the value z never exceeds y or goes below x:

$$Clip 3 ( x , y , z ) = \{ \begin{matrix}x ; & z < x \\ y ; & z > y \\ z ; & otherwise\end{matrix}$$

The clipping parameters “c[x]” are also to be signaled from the encoder to the decoder.

The ALF filter is designed to keep the DC gain, which means that the sum of all filter coefficients, including a coefficient for the current sample, is equal to 128. Based on this design, the modification of ALF of a sample can be derived based on equation 1466 where modification, excluding the clipping, equals the sum of difference between the current sample and a neighboring sample times respective filter coefficient. When referring to filter coefficients in this disclosure, we mainly refer to these filter coefficients (e.g., excluding the center filter coefficient).

A similar filter design as shown above is used for ALF of chroma components but without use of any classification.

In the reference software for VVC Test Model (VTM)-10.0, the filter coefficients and the clipping parameters are optimized in rate distortion sense (e.g., to minimize the mean squared error while also considering the bits for transmission of filter coefficients and clipping parameters).

Section 8.8.5.7 of the VVC Specification describes a cross-component filtering process. The text of this section is reproduced below.

8.8.5.7 Cross-Component Filtering Process

Inputs of this process are:
a reconstructed luma picture sample array recPicture_{L} prior to the luma adaptive loop filtering process,
a filtered reconstructed chroma picture sample array alfPicture_{C},
a chroma location (xCtbC, yCtbC) specifying the top-left sample of the current chroma coding tree block relative to the top-left sample of the current picture,
a CTB width ccAlfWidth in chroma samples,
a CTB height ccAlfHeight in chroma samples,
cross-component filter coefficients CcAlfCoeff[j], with j=0 . . . 6.
Output of this process is the modified filtered reconstructed chroma picture sample array ccAlfPicture.
For the derivation of the filtered reconstructed chroma samples
ccAlfPicture[xCtbC+x][yCtbC+y], each reconstructed chroma sample inside the current chroma block of samples alfPicturec[xCtbC+x][yCtbC+y] with x=0 . . . ccAlfWidth−1, y=0 . . . ccAlfHeight−1, is filtered as follows:
The luma location (xL, yL) corresponding to the current chroma sample at chroma location (xCtbC+x, yCtbC+y) is set equal to ((xCtbC+x)*SubWidthC, (yCtbC+y)*SubHeightC).
The luma locations (hₓ₊ᵢ, v_{y+j}) with i=−1 . . . 1, j=−1 . . . 2 inside the array recPicture_{L} are derived as follows:

hₓ₊ᵢ=Clip3(0,pic_width_in_luma_samples−1,xL+i) (1528)

v_{y+j}=Clip3(0,pic_height_in_luma_samples−1,yL+j) (1529)
The variables clipLeftPos, clipRightPos, clipTopPos, clipBottomPos, clipTopLeftFlag and clipBotRightFlag are derived by invoking the ALF boundary position derivation process as specified in clause 8.8.5.5 with (xCtbC*SubWidthC, yCtbC*SubHeightC) and (x*SubWidthC, y*SubHeightC) as inputs.
The variables hₓ₊ᵢ and v_{y+j} are modified by invoking the ALF sample padding process as specified in clause 8.8.5.6 with (xCtbC*SubWidthC, yCtbC*SubHeightC), (hₓ₊ᵢ, v_{y+j}), the variable isChroma set equal to 0, clipLeftPos, clipRightPos, clipTopPos, clipBottomPos, clipTopLeftFlag and clipBotRightFlag as input.
The variable applyAlfLineBufBoundary is derived as follows:
   If the bottom boundary of the current coding tree block is the bottom boundary of current picture and pic_height_in_luma_samples−yCtbC*SubHeightC is less then or equal to CtbSizeY−4, applyAlfLineBufBoundary is set equal to 0.
   Otherwise, applyAlfLineBufBoundary is set equal to 1.
The vertical sample position offsets yP1 and yP2 are specified in Table 47 according to the vertical luma sample position (y*subHeightC) and applyAlfLineBufBoundary.
The variable curr is derived as follows:

curr=alfPicturec[xCtbC+x][yCtbC+y] (1530)
The array of cross-component filter coefficients f[j] is derived as follows with j=0 . . . 6:

f[j]=CcAlfCoeff[j] (1531)
The variable sum is derived as follows:

sum=f[0]*(recPicture_{L}[hₓ][v_{y-yP1}]−recPicture_{L}[hₓ][v_{y}])+f[1]*(recPicture_{L}[hₓ₋₁][v_{y}]−recPicture_{L}[hₓ][v_{y}])+f[2]*(recPicture_{L}[hₓ₊₁][v_{y}]−recPicture_{L}[hₓ][v_{y}])+f[3]*(recPicture_{L}[hₓ₋₁][v_{y+yP1}]−recPicture_{L}[hₓ][v_{y}])+f[4]*(recPicture_{L}[hₓ][v_{y+yP1}]−recPicture_{L}[hₓ][v_{y}])+f[5]*(recPicture_{L}[hₓ₊₁][v_{y+yP1}]−recPicture_{L}[hₓ][v_{y}])+f[6]*(recPicture_{L}[hₓ][v_{y+yP2}]−recPicture_{L}[hₓ][v_{y}]) (1532)

scaledSum=Clip3(—(1<<(BitDepth−1)),(1<<(BitDepth−1))−1,(sum+64)>>7) (1533)

sum=curr+scaledSum (1534)
The modified filtered reconstructed chroma picture sample ccAlfPicture[xCtbC+x][yCtbC+y] is derived as follows:

ccAlfPicture[xCtbC+x][yCtbC+y]=Clip3(0,(1<<BitDepth)−1,sum) (1535)

### SUMMARY

One problem with the existing method for rate distortion optimization of filter coefficients in VVC Test Model (VTM) is that it only focuses on the minimization of error and rate and does not allow for flexible control of the filter strength for adaptive loop filter (ALF). Controlling the filter strength can be useful to avoid removing natural texture and also to give a desired amount of smoothing. Typically, the more filtering that is used, the smoother the image, and the more natural texture you lose, such as gravel, grass etc. At the same time, the less filtering that is used, the more artifacts remain in the image after ALF filtering. The current method for calculating the filters in VTM only look at the best peak signal-to-noise ratio (PSNR) for a certain bit rate, which may give an over-smoothed look.

Aspects of the invention may overcome one or more of the problems with the existing method for rate distortion optimization of filter coefficients in VTM by applying a scaling factor on determined ALF coefficients before encoding them into the video bitstream. In some aspects, applying the scaling factor on determined ALF coefficients may make sure that the strength of the filter is kept sufficiently low. Aspects of the invention may provide means to control the amount of filter strength for ALF. Aspects of the invention may provide improved visual quality of VVC (e.g., better visual quality than VTM-10.0).

According to the first aspect of the present invention there is provided a method performed by an encoder for encoding an image. The method comprises determining adaptive loop filter, ALF, coefficient values. The method comprises determining a scaling factor. The method further comprises generating scaled ALF coefficient values by applying the scaling factor to one or more of the ALF coefficient values. The method comprises providing the scaled ALF coefficient values to a decoder, wherein providing the scaled ALF coefficient values to the decoder comprises encoding the scaled ALF coefficient values in a bitstream and conveying the bitstream over a network. The determined ALF coefficient values reduce an error between reconstructed image components and original image components and the determined scaling factor improves subjective performance for image to be encoded.

In some embodiments, applying the scaling factor to one or more of the ALF coefficient values may include applying the scaling factor as a multiplication of the one or more of the ALF coefficient values in floating point representation. In some embodiments, applying the scaling factor to one or more of the ALF coefficient values may include applying the scaling factor as a multiplication, addition, and/or shift of one or more filter coefficients in fixed point representation.

In some embodiments, determining the ALF coefficient values may include solving a least-squares problem.

In some embodiments, determining the scaling factor may include determining a strength of filtering with the ALF coefficient values. In some embodiments, determining the strength of filtering with the ALF coefficient values may include calculating a sum of the absolute values of the ALF coefficient values. In some embodiments, determining the scaling factor may further include comparing the sum of the absolute values of the ALF coefficient values to 128. In some embodiments, determining the strength of filtering with the ALF coefficient values may include calculating a sum of the squares of the ALF coefficient values. In some embodiments, determining the strength of filtering with the ALF coefficient values may include calculating a square root of a sum of the squares of the ALF coefficient values. In some embodiments, the strength of filtering with the ALF coefficient values may be determined based on a quantization parameter (QP).

In some embodiments, the scaling factor may be determined based on the strength of filtering with the ALF coefficient values.

In some embodiments, determining the scaling factor may include determining a classification type (e.g., vertical/horizontal, diagonal, and non-oriented), and the determined scaling factor may be based on the determined classification type. In some embodiments, the determined scaling factor may be based on whether the image is an intra coded picture or an inter coded picture.

In some embodiments, the method may further include determining that the scaling factor is not below 1 and using fixed ALF coefficient values only if the determined scaling factor is not below 1. In some embodiments, the method may further include determining that a strength of filtering with fixed filter coefficients is less than a threshold and using the fixed ALF coefficient values only if the determined strength is less than the threshold.

In some embodiments, the method may further include quantizing the scaled ALF coefficient values and adjusting the quantized coefficient values. In some embodiments, the method may further include determining a strength of filtering with the scaled ALF coefficient values and determining a strength of filtering with the adjusted quantized coefficient values. In some embodiments, the adjusted quantized coefficient values may be such that the strength of filtering with the adjusted quantized coefficient values is not greater than the strength of filtering with the scaled ALF coefficient values by more than a threshold amount. In some embodiments, adjusting the quantized coefficient values may include only adjusting the quantized coefficient values if the determined scaling factor is less than 1.

According to the second aspect of the present invention there is provided an apparatus adapted to perform the method according to the first aspect.

According to the third aspect of the present invention there is provided a method performed by a decoder for decoding an image. The method comprises receiving scaled ALF coefficient values signaled by an encoder, reconstructing image components, and filtering the image components by applying the scaled ALF coefficient values to generate final reconstructed image components.

According to the fourth aspect of the present invention there is provided an apparatus adapted to perform the method according to the third aspect.

According to the fifth aspect of the present invention there is provided a computer program comprising instructions for adapting an apparatus to perform the method according to the first or the third aspect.

According to the sixth aspect of the present invention there is provided a carrier comprising the computer program, and the carrier may be one of an electronic signal, optical signal, radio signal, or compute readable storage medium.

According to the seventh aspect of the present invention there is provided an apparatus comprising processing circuitry and a memory, the memory comprising instructions executable by said processing circuitry, wherein the apparatus is operative to perform any of the methods set forth above.

### BRIEF DESCRIPTION OF THE DRAWINGS

The accompanying drawings, which are incorporated herein and form part of the specification, illustrate various embodiments.

FIG. 1 provides an illustration of coefficient reuse.

FIG. 2 illustrates a system comprising an encoder and a decoder according to some embodiments.

FIG. 3 illustrates an example encoder according to some embodiments.

FIG. 4 illustrates an example decoder according to some embodiments.

FIGS. 5A-5C and 6A-6C illustrate the effect of reducing filter strength on a sequence where ALF is used a lot.

FIG. 7 is a flow chart illustrating a process according to some embodiments.

FIG. 8 is a block diagram of an apparatus according to one embodiment.

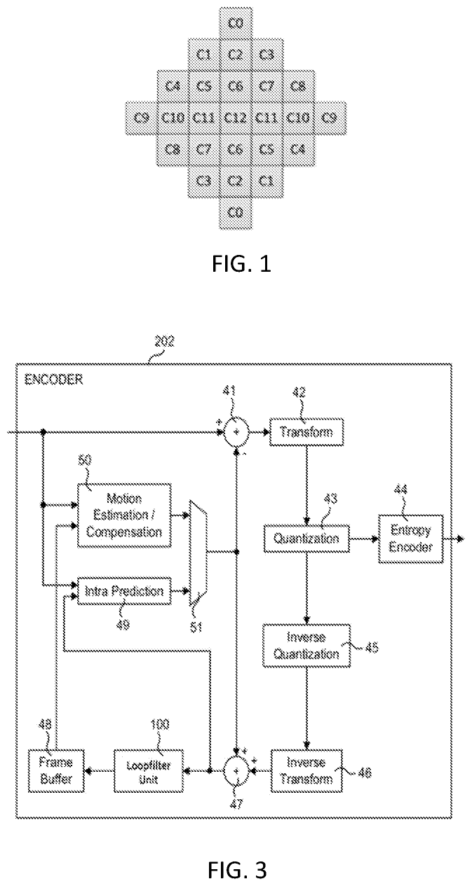

### DETAILED DESCRIPTION

System

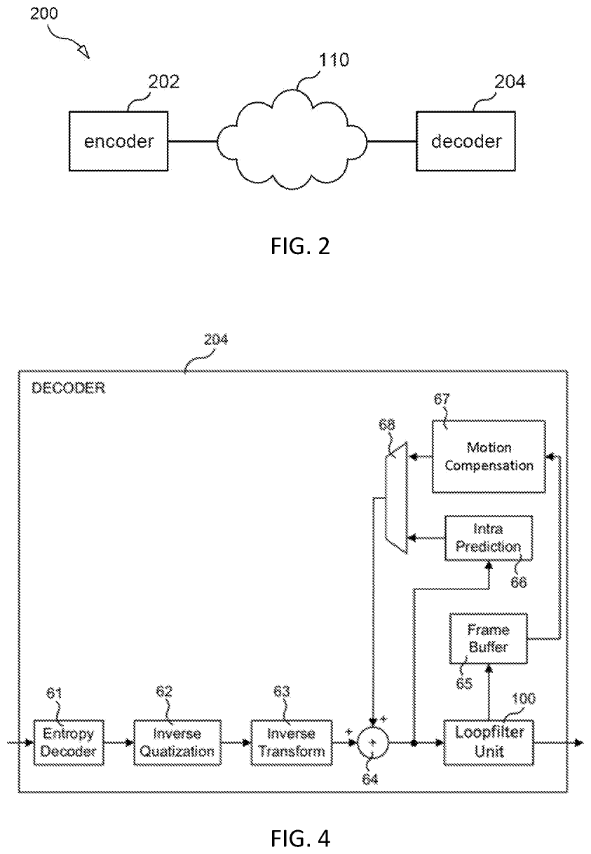

FIG. 2 illustrates a system 200 according to an example embodiment. System 200 includes an encoder 202 and a decoder 204. In the example shown, decoder 204 receives, via a network 110 (e.g., the Internet or other network), encoded images produced by encoder 202.

FIG. 3 is a schematic block diagram of encoder 202. As illustrated in FIG. 3, the encoder 202 takes in an original image and subtracts a prediction 41 that is selected 51 from either previously decoded samples (“Intra Prediction” 49) or samples from previously decoded frames stored in the frame buffer 48 through a method called motion compensation 50. The task of finding the best motion compensation samples is typically called motion estimation 50 and involves comparing against the original samples. After subtracting the prediction 41 the resulting difference is transformed 42 and subsequently quantized 43. The quantized results are entropy encoded 44 resulting in bits that can be stored, transmitted or further processed. The output from the quantization 43 is also inversely quantized 45 followed by an inverse transform 46. Then the prediction from 51 is added 47 and the result is forwarded to both the intra prediction unit 49 and to the loop filter 100. The loop filter 100 may do deblocking, SAO, and/or ALF filtering. The result is stored in the frame buffer 48, which is used for future prediction. Not shown in the figure is that coding parameters for other blocks such as 42, 43, 49, 50, 51 and 100 also may also be entropy coded.

FIG. 4 is a corresponding schematic block diagram of decoder 204 according to some embodiments. The decoder 204 takes in entropy coded transform coefficients which are then decoded by decoder 61. The output of decoder 61 then undergoes inverse quantization 62 followed by inverse transform 63 to form a decoded residual. To this decoded residual, a prediction is added 64. The prediction is selected 68 from either a motion compensation unit 67 or from an intra prediction unit 66. After having added the prediction to the decoded residual 64, the samples can be forwarded for intra prediction of subsequent blocks. The samples are also forwarded to the loop filter 100, which may do deblocking, SAO processing, and/or adaptive ALF processing. The output of loop filter 100 is forwarded to the frame buffer 65, which can be used for motion compensation prediction of subsequently decoded images 67. The output of the loop filter 100 can also output the decoded images for viewing or subsequent processing outside the decoder. Not shown in the figure is that parameters for other blocks such as 63, 67, 66, and 100 may also be entropy decoded. As an example, the coefficients for the ALF filter in block 100 may be entropy decoded.

In some embodiments, the encoder 202 (e.g., the ALF portion of the loop filter 100 of the encoder 202) may be configured to determine ALF coefficient values, determine one or more scaling factors, and to generate scaled ALF coefficient values by applying the one or more scaling factors to the determined ALF coefficient values. The encoder 202 may signal the scaled ALF coefficient values to the decoder 204 (e.g., by encoding them into the video bit stream). The decoder 204 may be configured to use the scaled ALF coefficient values to decode an image. That is, the decoder 204 may be configured to reconstruct image components (e.g., to get Y_{SAO}, Cb_{SAO}, and Cr_{SAO}) and obtain the scaled filter coefficients from the bit stream, and the decoder 204 (e.g., the ALF portion of the loop filter 100 of the decoder 204) may be configured to filter the image components by applying the scaled ALF coefficient values to generate the final reconstructed image components (e.g., Y_{ALF}, Cb_{ALF}, and Cr_{ALF}).

In some embodiments, the system 200 may use the one or more scaling factors to control the strength of ALF filtering. In some embodiments, a scaling factor may attenuate or amplify the strength of the ALF filter. For example, in some embodiments, a scaling factor that is below 1 may attenuate the strength of the ALF filter, a scaling factor that is above 1 may amplify the strength of the ALF filter, and a scaling factor that is equal to 1 may keep the filter strength the same.

In some embodiments, the encoder 204 (e.g., the ALF portion of the loop filter 100 of the encoder 202) may apply a scaling factor as a multiplication of one or more filter coefficients in floating point representation (e.g., Cnew(i)=C(i)*sf, where C(i) are the filter coefficients for non-center neighboring samples, and sf is the scaling factor). In some alternative embodiments, the encoder 204 (e.g., the ALF portion of the loop filter 100 of the encoder 202) may apply a scaling factor as a multiplication, addition, and/or shift of one or more filter coefficients in fixed point representation (e.g., Cnew(i)=C(i)>>sfShift, where C(i) are the filter coefficients for non-center neighboring samples, and 2\hat{ }(−sfShift) is the scaling factor).

In some embodiments, determining one or more scaling factors may include determining one or more strengths of filtering (e.g., ALF filtering). In some embodiments, the encoder 202 may determine the strength of filtering as the sum of the absolute value of filter coefficients. In some alternative embodiments, the encoder 202 may determine the strength of filtering as the sum of the squares of the filter coefficients. In some other alternative embodiments, the encoder 202 may determine the strength of filtering as the square root of the sum of the squares of the filter coefficients. In some further alternative embodiments, the encoder 202 may determine the strength of filtering based on a quantization parameter (QP).

In some embodiments, the one or more scaling factors may be determined based on the one or more determined filter strengths. In some embodiments, determining the one or more scaling factors may include comparing the one or more determined strengths of filtering to one or more strength thresholds (e.g., a scaling factor that attenuates the filter strength may be used if the filter strength is above a strength threshold).

### Filter Strength Calculation by Sum of Absolute Values (Example 1)

In some embodiments, the strength of ALF filtering is calculated by the sum of the absolute value of filter coefficients. In some embodiments, in floating point arithmetic, a sum of 1 may correspond to a filter that is un-restricted, a sum below 1 may correspond to a filter that is attenuated, and a sum above 1 may correspond to a filter that is amplified. In some fixed point arithmetic embodiments with a quantization of 1/128, a sum of 128 corresponds to a filter that is un-restricted, a sum below 128 corresponds to a filter that is attenuating, and a sum above 128 corresponds to a filter that has amplification.

### Scaling Factors for Positive and Negative Filter Coefficients (Example 2)

In some embodiments, the encoder 202 may determine the strength of filtering separately for positive filter coefficients and negative filter coefficients. In some embodiments, the strength of filtering for positive filter coefficients may be the sum of positive filter coefficients, and the strength of filtering for negative filter coefficients may be the sum of negative filter coefficients.

Positive filter coefficients decrease the sample distance between the current sample and the neighboring samples with positive coefficients. Negative filter coefficients increase the sample distance between the current sample and the neighboring samples with negative coefficients.

In some embodiments, to control the strength of filtering, a first scaling factor may be used for positive filter coefficients, and a second scaling factor may be used for negative filter coefficients.

In some embodiments, a first scaling factor for positive filter coefficients that is equal to 1 and a second scaling factor for negative filter coefficients that is less than 1 may increase the low-pass effect of the filter. In some embodiments, a first scaling factor for positive filter coefficients that is equal to 1 and a second scaling factor for negative filter coefficients that is greater than 1 may increase the high-pass effect of the filter.

### Fixed Filter Coefficients (Example 3)

In some embodiments where ALF allows for the use of fixed filter coefficients (e.g., pre-determined by the specification) that have varying filter strength, the use of fixed filter coefficients may be avoided when applying a scaling factor below 1. This may enable full control of the filter strength for ALF.

Some alternative embodiments may allow for usage of fixed filter coefficients that have a filter strength less than a threshold.

### Fine-Tuning (Example 4)

In some embodiments, to enable control of the filter strength of ALF as part of filter optimization or filter selection, a maximum filter strength may be defined and kept track of during optimization and filter selection, and solutions that deviate too much from the maximum filter strength may be avoided.

In some embodiments, after filter coefficients have been quantized, the filter coefficients can be tuned to achieve better objective distortion and/or rate distortion by increasing or decreasing the filter coefficients from the quantized values. This adjustment of filter coefficients after quantization may be referred to as “fine-tuning”. By determining the filter strength before quantization and avoiding refinements in the fine-tuning stage that increase the filter strength more than a threshold, the strength of the filter can be maintained as part of the refinement. In some embodiments, refinement of filter coefficients after quantization may be omitted when the scaling factor is less than 1.

In some embodiments, this means that a condition may be added to the optimization so that the strength of the filter is kept constant during the optimization. As an example, this may mean that, if one coefficient is increased, another one must be decreased to arrive at a filter with the same strength. If the strength is measured as the sum of absolute values of the coefficients, this means that the sum of absolute values of the coefficients must be the same (or almost the same) during the optimization. If the strength is instead measured as the squared sum of absolute values of the coefficients, then the optimization instead must make sure that this measure does not change during optimization. This can be accomplished by minimizing the loss function:

$$L = BDrate ( {d}_{k} ) + {λ [ ( {\sum }_{k = 0}^{12} {c}_{k}^{2} ) - ( {\sum }_{k = 0}^{12} {d}_{k}^{2} ) ]}^{2}$$

Where cₖ is the coefficients before optimization and dₖ is a coefficient after optimization, and BDrate(dₖ) is the loss function that has traditionally been minimized. This can for instance be done by taking steps in the gradient of L,

$$Δ {d}_{k} = - α \frac{\partial L}{\partial {d}_{k}} ,$$

for a sufficiently small step size α such as α=0.001, and then update the coefficients using dₖ^{new}=dₖ^{old}+Δdₖ. The variable λ is used to set the balance between keeping the same strength (large λ) and between lowering the BD-rate penalty (small λ).

If instead the strength of the filter is measured as the sum of absolute values of the coefficients in the filter, the following loss function may instead be used:

$$L = BDrate ( {d}_{k} ) + {λ [ ( {\sum }_{k = 0}^{12} \vert {c}_{k}^{2} \vert ) - ( {\sum }_{k = 0}^{12} \vert {d}_{k}^{2} \vert ) ]}^{2} .$$

Another way of ensuring the same strength is to test pairs of coefficients, where one coefficient is moved to increase the filter strength and the other coefficient is moved to decrease the filter strength by an equal amount or more. If the new combination results in a lower BDrate loss measure, the optimization procedure executes the change, and otherwise leaves it unchanged. It then proceeds to the next pair of coefficients.

In some alternative embodiments, after “optimal” filter coefficients have been obtained, the “optimal” filter coefficients may be merged such that fewer filters are defined due to rate distortion preference. Doing so can alter the filter strength of the merged filter compared to the filter strength of the “optimal” filter, and this can enable use of a stronger filter than necessary. By determining the filter strength before merging filters, mergings that results in filters that deviates too much from the “optimal” filter strengths may be avoided. In some embodiments, merging of filter coefficients may be omitted when the scaling factor is less than 1.

Some further alternative embodiments may include determining the optimal filter coefficients for a coding tree unit (CTU), determining the filter strength for respective filters, and then selecting filter coefficients (after merging, quantization, refinement) that maintain the determined filter strength and otherwise omit ALF for that CTU.

### Quantization Parameter (QP) (Example 5)

In some embodiments, the filter strength of ALF may be controlled by the quantization parameter (QP). In some embodiments, a scaling factor less than 1 may be used to reduce the magnitude of the filter coefficients when QP is larger than a threshold (e.g., 36). In some embodiments, a filter strength larger than a QP dependent threshold is not allowed.

### Scaling Factor Selection (Example 6)

In some embodiments, a scaling factor may be selected by testing different scaling factors and using the scaling factor that improves subjective performance for the content to be encoded. In some alternative embodiments, a scaling factor may be selected automatically by testing different scaling factors and selecting the scaling factor that maintains most of the objective performance of a non-scaled approach.

### Filter Strength Control for Different Classification Types (Example 7)

In some embodiments, the filter strength can be controlled individually for different classification types (e.g., vertical/horizontal, diagonal, and non-oriented). In some embodiments, a specific scaling factor may be used for each of the respective classifications, and the scaling factors for the respective classifications may be different from one another.

### Filter Strength Control for Intra vs. Inter Coded Pictures (Example 8)

In some embodiments, the filter strength may be controlled differently for intra coded pictures than for inter coded pictures. In some embodiments, only filter strengths equal to or less than a pre-defined filter strength may be allowed.

### Filter Strength Calculation by Sum of Squares (Example 9)

In some embodiments, the filter strength may be controlled by measuring the sum of the squares of the filter coefficients. As an example, if c0=10, c1=0, c2=−20, c3 through c10=30, and c11=−40, then then sum of the squares of the filter coefficients is 10\hat{ }2+0\hat{ }2+(−20)\hat{ }2+8*(30)\hat{ }2+(−40)\hat{ }2=9300.

In some embodiments, the encoder 202 may calculate a filter strength measure for all of the filters affecting an image. The maximum filter strength calculated for the filters affecting an image may be regarded as full strength. As an example, if there are four filters that affect an image, and their strength measures are 9300, 3200, 4600, and 10200, respectively, the encoder 202 may regard 10200 as full strength.

In some embodiments, the encoder 202 may apply a scaling factor to each of the filters that has a filter strength above a filter strength threshold. In some embodiments, the filter strength threshold may be a percentage or a fraction of the full strength measure. For example, a threshold factor of s=1.0 may result in no change to the filters because no filter will have a filter strength above the full strength measure (e.g., 10200×1.0). However, if the threshold factor is s=0.75, the encoder may make sure that no filter gets a strength larger than 0.75*10200=7650. This means that the filters with strength 3200 and 4600 will not be changed, but the filters with strength 9300 and 10200 will be scaled down until their strength is less than or equal to 7650. In some embodiments, scaling down the filters may be done by multiplying the filter coefficients with a factor r until the filter is below the strength threshold. In the example where c0=10, c1=0, c2=−20, c3 through c10=30, and c11=−40, scaling every filter coefficient with r=0.9 will give the new filter coefficients c0=9, c2=−18, c3 through c10=27, and c11=−36, and the strength after the scaling will become 7533, which is less than the filter strength threshold of 7650.

In some embodiments, the encoder 202 may determine the scaling factor r as:

r=sqrt(s*maxstrength/strength)=sqrt(0.75*10200/9300)=sqrt(0.8226)=0.9070.

In some embodiments, this scaling with a factor of r may be performed before quantization. However, this is not required, and, in some alternative embodiments, this scaling with a factor of r may be performed after quantization but before fine-tuning. In some additional embodiments, the scaling with a factor of r may instead be performed after fine tuning.

### Filter Strength Calculation by Square Root of Sum of Squares (Example 10)

Some alternative embodiments may be similar to the embodiments using the sum of the squares of the filter coefficients as a measure for filter strength but may instead use the square root of the sum of squares of the filter coefficients as a measure for filter strength. As an example, if c0=10, c1=0, c2=−20, c3 through c10=30, and c11=−40, then the sum of the squares of the filter coefficients is 10\hat{ }2+0\hat{ }2+(−20)\hat{ }2+8*(30)\hat{ }2+(−40)\hat{ }2=9300, and the measure is sqrt(9300)=96.44.

In some embodiments, the encoder 202 may calculate this measure for all the filters affecting an image. The maximum filter strength measure calculated for the filters affecting an image may be regarded as full strength. As an example, if there are four filters, and their strength measures are 96.44, 56.57, 67.82, and 100.99, respectively, the encoder 202 may regard 100.99 as full strength.

In some embodiments, the encoder 202 may apply a scaling factor to each of the filters that has a filter strength above a filter strength threshold. In some embodiments, the filter strength threshold may be a percentage or a fraction of the full strength measure. In some embodiments, the filter strength threshold may be equal to the full strength measure multiplied by a threshold factor s. For example, a threshold factor of s=1.0 may result in no change to the filters because none of the filters will have a filter strength above the full strength measure (e.g., 100.99×1.0). However, if the threshold factor is s=0.75, the encoder may make sure that no filter gets a strength larger than 0.75*100.99=75.75. This means that the filters with strength 56.57 and 67.8 will not be changed, but the filters with strength 96.44 and 100.99 will be scaled down until their strength is less than or equal to 75.75. In some embodiments, scaling down the filters may be done by multiplying the filter coefficients with a factor r until the filter is below the strength threshold. In the example where c0=10, c1=0, c2=−20, c3 through c10=30, and c11=−40, scaling every filter coefficient with r=0.7 will give the new filter coefficients c0=7, c2=−14, c3 through c10=21, and c11=−28, and the strength after the scaling will become 67.50, which is less than the filter strength threshold of 75.75 and will satisfy the criterion. However, scaling every filter coefficient with r=0.8 will give the new filter coefficients c0=8, c2=−16, c3 through c10=24, and c11=−32, and the strength after the scaling will become 77.14, which is higher than 75.75 and may not satisfy the criterion.

In some embodiments, the encoder 202 may determine the scaling factor r that perfectly hits the target as:

r=s*maxstrength/strength=0.75*sqrt(10200)/sqrt(9300)=sqrt(0.8226)=0.7855.

Because the coefficients may need to be rounded to integers afterwards, this calculated scaling factor r may still not hit the target exactly. In our example, multiplying with 0.7855 will give c0=7.854524, c1=0, c2=−15.709048, c3 through c10=23.563572 and c11=−31.418096. After rounding to integers we get c0=8, c1=0, c2=−16, c3 through c10=24 and c11=31, which gives the strength sqrt(5889)=76.74 which is too high. However, in some embodiments, the encoder 202 may nonetheless regard the scaled filter coefficients as close enough. Hence, in some embodiments, the encoder 202 may determine the filter coefficients by calculating the scaling factor r that perfectly hits the target, applying the calculated scaling factor to the filter coefficients, and then rounding each of the scaled filter coefficients to the closest integer.

### Filter Strength Control Based on ALF Use (Example 11)

In some embodiments, the encoder 202 may control the filter strength based on how much ALF is used. In some embodiments, the encoder 202 may set a scaling factor that reduced the filter strength if ALF is used a lot.

Results: Visual Comparison

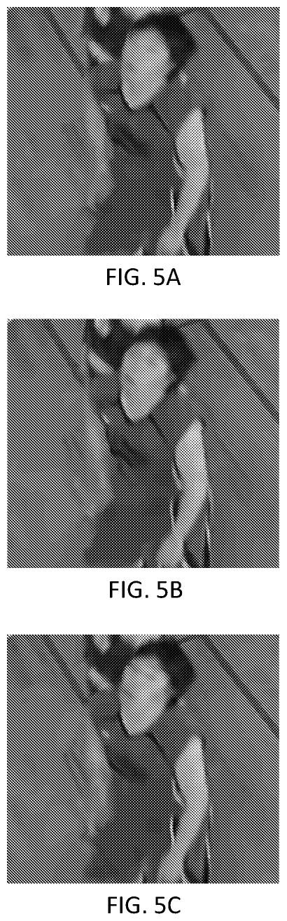

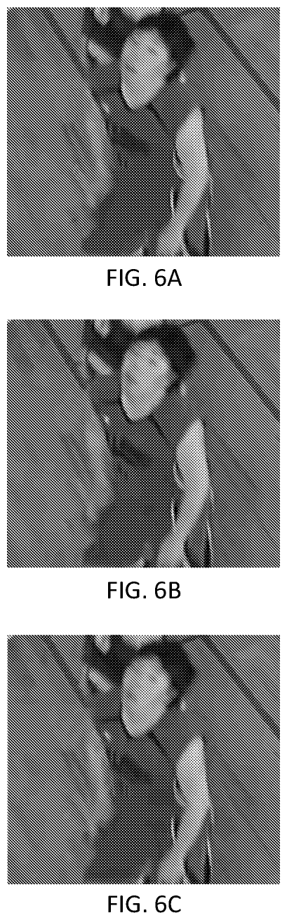

It may be hard to visualize video quality with a frame. However, as shown in FIGS. 5A-5C and 6A-6C, on sequences where ALF is used a lot (e.g., like on BasketballDrill), a reduction of the filter strength (e.g., by setting a scaling factor that is attenuates the filter strength) may reduce amount of blurring. FIGS. 5A-5C illustrate a BasketballDrill LDB at QP 37 and Picture Order Count (POC) 599. FIG. 5A-5C illustrate VTM-10.0, ALFstrength equal to 0.75, and ALFstrength equal to 0.5, respectively. FIG. 6A-6C illustrate the BasketballDrill LDB at QP 32 and POC 59. FIG. 6A-6C illustrate VTM-10.0, ALFstrength equal to 0.75, and ALFstrength equal to 0.5, respectively.

Results: Objective Comparison

Bjøntegaard delta rate results for Example 1 with a scaling factor of 0.75 when compared against VTM-10.0 are shown in the tables below. A figure of −1% means that it is possible to reach the same measured distortion with 1% less bits. The results indicate that the solution in embodiment 1 can be set to maintain the BDR of ALF but with less filter strength. Most of the objective benefit of ALF can be kept with a scaling factor of 0.75. In the tables below, values that have not yet been determining are indicated with a “TBD.”

The table below shows all intra over VTM-10.0:

| | Y | U | V |
|---|---|---|---|
| Class A1 | 0.18% | 0.49% | 0.55% |
| Class A2 | TBD | TBD | TBD |
| Class B | 0.24% | 0.17% | 0.29% |
| Class C | 0.26% | 0.18% | 0.30% |
| Class E | 0.45% | 0.24% | 0.29% |
| Overall | TBD | TBD | TBD |
| Class D | 0.21% | 0.30% | 0.41% |
| Class F | TBD | TBD | TBD |

The table below shows random access over VTM-10.0:

| | Y | U | V |
|---|---|---|---|
| Class A1 | 0.31% | 0.20% | 0.34% |
| Class A2 | 0.44% | 0.18% | 0.06% |
| Class B | 0.38% | 0.19% | 0.24% |
| Class C | 0.19% | −0.12% | −0.02% |
| Class E | | | |
| Overall | 0.33% | 0.10% | 0.16% |
| Class D | 0.22% | −0.38% | −0.20% |
| Class F | 0.22% | 0.09% | 0.18% |

The table below shows low-delay B over VTM-10.0:

| | Y | U | V |
|---|---|---|---|
| Class A1 | | | |
| Class A2 | | | |
| Class B | TBD | TBD | TBD |
| Class C | 0.20% | −0.06% | −0.16% |
| Class E | 0.42% | 0.30% | 0.06% |
| Overall | TBD | TBD | TBD |
| Class D | 0.21% | 0.23% | −0.41% |
| Class F | 0.11% | 0.67% | 0.35% |

Flowcharts

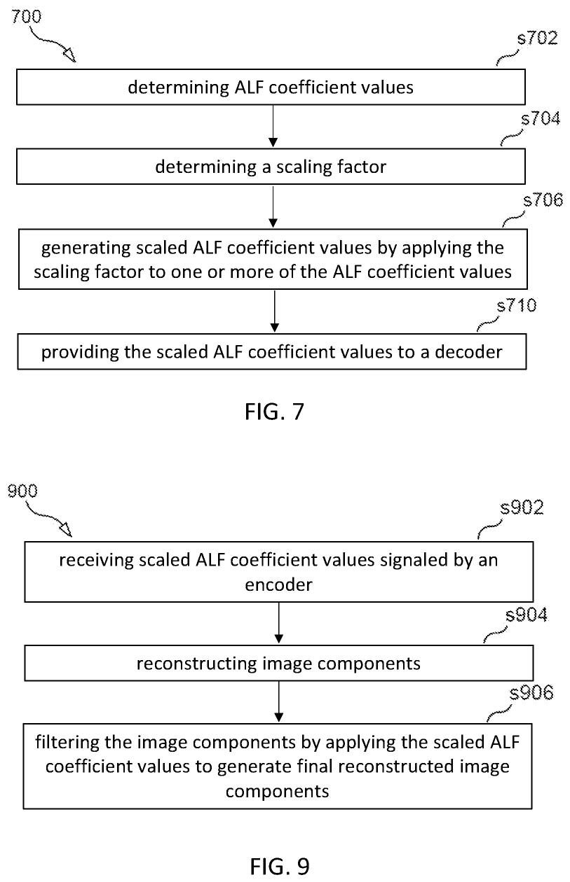

FIG. 7 illustrates a process 700 performed by the encoder 202 according to some embodiments. In some embodiments, the process 700 may be for encoding an image.

In some encoding embodiments, the process 700 may include a step 702 of determining ALF coefficient values. In some embodiments, the ALF coefficient values may be adaptive loop filter (ALF) coefficient values. In some embodiments, the ALF portion of the loop 100 may determine the ALF coefficient values.

In some embodiments, determining the ALF coefficient values in step 702 may include solving a least-squares problem. In some embodiments, the determined ALF coefficient values may reduce an error between reconstructed image components (e.g., Y_{SAO}, Cb_{SAO}, and Cr_{SAO}) and original image components (e.g., Y_{org}, Cb_{org}, and Cr_{org}).

In some encoding embodiments, the process 700 may include a step 704 of determining a scaling factor. In some embodiments, the determined scaling factor may improve subjective performance for image to be encoded. In some embodiments, the determined scaling factor may maintain most of the objective performance of a non-scaled approach.

In some embodiments, determining the scaling factor in step 704 may include determining a strength of filtering with the ALF coefficient values. In some embodiments, determining the strength of filtering with the ALF coefficient values may include calculating a sum of the absolute values of the ALF coefficient values. In some alternative embodiments, determining the strength of filtering with the ALF coefficient values may include calculating a sum of the squares of the ALF coefficient values. In some other alternative embodiments, determining the strength of filtering with the ALF coefficient values may include calculating a square root of a sum of the squares of the ALF coefficient values. In some embodiments, the strength of filtering with the ALF coefficient values may be determined based on a quantization parameter (QP).

In some embodiments, the scaling factor may be determined in step 704 based on the strength of filtering with the ALF coefficient values. In some embodiments, determining the scaling factor in step 704 may include comparing the determined strength of filtering with the ALF coefficient values to a strength threshold (e.g., comparing the sum of the absolute values of the ALF coefficient values to a strength threshold of 128 or comparing the QP to a strength threshold of 36). In some embodiments, determining the scaling factor in step 704 may include determining that the strength of filtering with the ALF coefficient values is larger than a strength threshold and, if the strength of filtering with the ALF coefficient values is determined to be larger than the strength threshold, setting the scaling factor such that a strength of filtering with the scaled ALF coefficient values is less than or equal to the strength threshold. In some embodiments, determining the scaling factor in step 704 may include determining that the strength of filtering with the ALF coefficient values is larger than a strength threshold and, if the strength of filtering with the ALF coefficient values is determined to be larger than the strength threshold, setting the scaling factor to be less than 1.

In some embodiments, the process 700 (e.g., step 704 of the process 700) may include determining the strength threshold to which the determined strength of filtering with the ALF coefficient values is compared. In some embodiments, determining the strength threshold may include (i) for each filter affecting the image, determining a strength of filtering with ALF coefficient values of the filter and (ii) multiplying a threshold factor by a maximum determined strength of the filters affecting the image. In some embodiments (e.g., embodiments where the determined strength of filtering with the ALF coefficient values is the calculated sum of the squares of the ALF coefficient values), the determined scaling factor may be equal to sqrt(s*maxstrength/strength), where sqrt is the square root, s is the threshold factor, maxstrength is the maximum determined strength of the filters affecting the image, and strength is the determined strength of filtering with the ALF coefficient values. In some embodiments (e.g., embodiments where the determined strength of filtering with the ALF coefficient values is the calculated square root of the sum of the squares of the ALF coefficient values), the determined scaling factor may be equal to s*maxstrength/strength, where s is the threshold factor, maxstrength is the maximum determined strength of the filters affecting the image, and strength is the determined strength of filtering with the ALF coefficient values.

In some embodiments, determining the scaling factor in step 704 may include determining a classification type (e.g., one of vertical/horizontal, diagonal, and non-oriented), and the determined scaling factor may be based on the determined classification type. In some embodiments, the scaling factor determined in step 704 may additionally or alternatively be based on whether the image is an intra coded picture or an inter coded picture.

In some embodiments, the process 700 may include steps of determining that the scaling factor is not below 1 and using fixed ALF coefficient values only if the determined scaling factor is not below 1. In some embodiments, the process 700 may include steps of determining that a strength of filtering with fixed filter coefficients is less than a threshold and using the fixed ALF coefficient values only if the determined strength is less than the threshold.

In some encoding embodiments, the process 700 may include a step 706 of generating scaled ALF coefficient values. In some embodiments, generating the scaled ALF coefficient values may include applying the scaling factor to one or more of the ALF coefficient values, and the scaled ALF coefficient values may be for use by the decoder 204 in filtering image components.

In some embodiments, applying the scaling factor to one or more of the ALF coefficient values in step 706 may include applying the scaling factor as a multiplication of the one or more of the ALF coefficient values in floating point representation. In some alternative embodiments, applying the scaling factor to one or more of the ALF coefficient values in step 706 may include applying the scaling factor as a multiplication, addition, and/or shift of one or more filter coefficients in fixed point representation.

In some embodiments, the process 700 (e.g., the step 706 of the process 700) may include rounding the scaled coefficients to the closest integer, and the rounded scaled coefficients may be used by the decoder 204 to in filtering image components.

In some embodiments, the process 700 may include an optional step 708 of quantizing the scaled ALF coefficient values. In some embodiments, ALF coefficient values and cross-component (CC) ALF coefficient values may be derived in floating point. In some embodiments where ALF coefficient values are derived in floating point, the ALF coefficient values in floating point may be quantized by multiplying them by 128 and then rounding them to integer values, the max value may be 128, and the min value may be −128. In some embodiments where CC ALF coefficient values are derived in floating point, the CC ALF filter coefficients may be quantized by representing them in multiples of 2, the max value may be 64, and the min value may be −64.

In some embodiments, the optional step 708 may additionally include adjusting the quantized coefficient values. In some embodiments, the step 708 may include determining a strength of filtering with the scaled ALF coefficient values and determining a strength of filtering with the adjusted quantized coefficient values. In some embodiments, the adjusted quantized coefficient values may be such that the strength of filtering with the adjusted quantized coefficient values are not greater than the strength of filtering with the scaled ALF coefficient values by more than a threshold amount. In some embodiments, adjusting the quantized coefficient values may include only adjusting the quantized coefficient values if the determined scaling factor is less than 1. In some embodiments, the optional step 708 may include determining optimal filter coefficients for a coding tree unit (CTU) and determining a strength of filtering with the optimal ALF coefficient values, and the adjusted quantized coefficient values may maintain the determined strength of filtering with the optimal ALF coefficient values.

In some embodiments, the process 700 may include an optional step 710 of providing the scaled ALF coefficient values to the decoder 204. In some embodiments, the scaled ALF coefficient values provided to the decoder 204 may be the quantized coefficient values (or the adjusted quantized coefficient values). In some embodiments, providing the scaled ALF coefficient values to the decoder 204 may include encoding the scaled ALF coefficient values in a bitstream and conveying the bitstream over the network 110.

In some embodiments, the process 700 may include avoiding merging of ALF coefficient values when the scaling factor is less than 1.

In some embodiments, the scaling factor determined in step 704 may be a first scaling factor, the one or more of the ALF coefficient values to which the first scaling factor is applied in step 706 may be a first set of the ALF coefficient values, the process 700 (e.g., the step 704 of the process 700) may include determining a second scaling factor, and generating the scaled ALF coefficient values in step 706 may include applying the second scaling factor to one or more of the ALF coefficient values in a second set of the ALF coefficient values. In some embodiments, the first set of the ALF coefficient values may be positive filter coefficients, and the second set of the ALF coefficient values may be negative ALF coefficient values. In some embodiments, determining the first scaling factor may include determining a first strength of filtering, and determining the second scaling factor may include determining a second strength of filtering. In some embodiments, determining the first strength of filtering may include calculating a sum of the first set of the ALF coefficient values, and determining the second strength of filtering may include calculating a sum of the second set of the ALF coefficient values. In some embodiments, the first scaling factor may be determined based on the first strength of filtering, and the second scaling factor may be determined based on the second strength of filtering.

FIG. 9 illustrates a process 900 performed by the decoder 204 according to some embodiments. In some embodiments, the process 900 may be for decoding an image. In some embodiments, the process 900 may include a step 902 of receiving scaled ALF coefficient values signaled by the encoder 202. In some embodiments, the process 900 may include a step 904 of reconstructing image components (e.g., to get Y_{SAO}, Cb_{SAO}, and Cr_{SAO}). In some embodiments, the process 900 may include a step 906 of filtering the image components by applying the scaled ALF coefficient values to generate final reconstructed image components (e.g., Y_{ALF}, Cb_{ALF}, and Cr_{ALF}). In some embodiments, a portion of the loop filter 100 of the decoder 204 may be adapted to perform adaptive loop filtering in which the image components are reconstructed, and the scaled ALF coefficient values are applied.

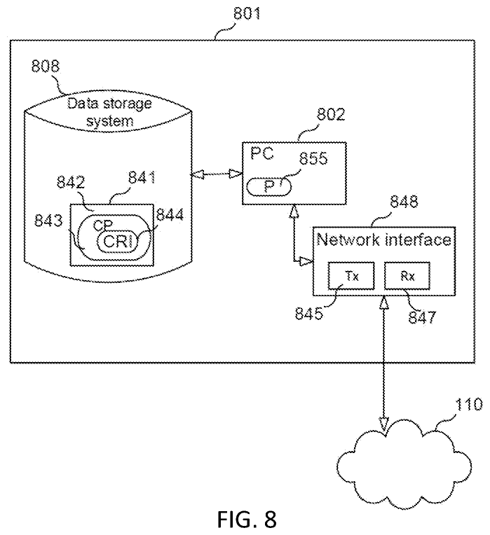

FIG. 8 is a block diagram of an apparatus 801 for implementing the encoder 202 or the decoder 204 according to some embodiments. That is, apparatus 801 can be adapted to perform the methods disclosed herein. In embodiments where the apparatus 801 implements the encoder 202, the apparatus 801 may be referred to as “encoding apparatus 801,” and, in embodiments where the apparatus 801 implements the decoder 204, the apparatus 801 may be referred to as a “decoding apparatus 801.” As shown in FIG. 8, the apparatus 801 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed; one or more network interfaces 848 (which may be co-located or geographically distributed) where each network interface includes a transmitter (Tx) 845 and a receiver (Rx) 847 for enabling apparatus 801 to transmit data to and receive data from other nodes connected to network 110 (e.g., an Internet Protocol (IP) network) to which network interface 848 is connected; and one or more storage units (a.k.a., “data storage systems”) 808 which may be co-located or geographically distributed and which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is adapted such that when executed by PC 802, the CRI causes apparatus 801 to perform steps described herein (e.g., steps described herein with reference to the flow charts). In other embodiments, apparatus 801 may be adapted to perform steps described herein without the need for code. That is, for example, PC 802 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method, performed by an encoder, for encoding an image, the method comprising:
determining adaptive loop filter (ALF) coefficient values;
determining a scaling factor;
generating scaled ALF coefficient values by applying the scaling factor to one or more of the ALF coefficient values; and
providing the scaled ALF coefficient values to a decoder, wherein providing the scaled ALF coefficient values to the decoder comprises encoding the scaled ALF coefficient values in a bitstream and conveying the bitstream over a network,
wherein the determined ALF coefficient values reduce an error between reconstructed image components and original image components and wherein the determined scaling factor improves subjective performance for image to be encoded.

2. The method of claim 1, wherein applying the scaling factor to one or more of the ALF coefficient values comprises applying the scaling factor as a multiplication of the one or more of the ALF coefficient values in floating point representation or applying the scaling factor as a multiplication, addition, and/or shift of one or more filter coefficients in fixed point representation.

3. The method of claim 1, wherein determining the ALF coefficient values comprises solving a least-squares problem.

4. The method of claim 1, wherein determining the scaling factor comprises determining a strength of filtering with the ALF coefficient values.

5. The method of claim 4, wherein determining the strength of filtering with the ALF coefficient values comprises calculating one of: a sum of the absolute values of the ALF coefficient values, a sum of the squares of the ALF coefficient values or a square root of a sum of the squares of the ALF coefficient values.

6. The method of claim 4, wherein determining the scaling factor further comprises comparing the sum of the absolute values of the ALF coefficient values to 128.

7. The method of claim 4, wherein the strength of filtering with the ALF coefficient values is determined based on a quantization parameter (QP).

8. The method of claim 4, wherein determining the scaling factor further comprises comparing the determined strength of filtering with the ALF coefficient values to a strength threshold.

9. The method of claim 1, wherein determining the scaling factor comprises determining a classification type, wherein the classification type is one of vertical/horizontal, diagonal, and non-oriented, and the determined scaling factor is based on the determined classification type.

10. The method of claim 1, wherein the determined scaling factor is based on whether the image is an intra coded picture or an inter coded picture.

11. The method of claim 1, further comprising:
determining that the scaling factor is not below 1; and
using fixed ALF coefficient values only if the determined scaling factor is not below 1.

12. The method of claim 1, further comprising:
quantizing the scaled ALF coefficient values;
adjusting the quantized coefficient values;
determining a strength of filtering with the scaled ALF coefficient values; and
determining a strength of filtering with the adjusted quantized coefficient values, wherein the adjusted quantized coefficient values are such that the strength of filtering with the adjusted quantized coefficient values is not greater than the strength of filtering with the scaled ALF coefficient values by more than a threshold amount.

13. The method of claim 12, wherein adjusting the quantized coefficient values comprises only adjusting the quantized coefficient values if the determined scaling factor is less than 1.

14. The method of claim 1, wherein determining the scaling factor comprising determining how much adaptive loop filtering is used, and the scaling factor is determined based on how much adaptive loop filtering is used.

15. An apparatus adapted to:
determine adaptive loop filter (ALF) coefficient values;
determine a scaling factor;
generate scaled ALF coefficient values by applying the scaling factor to one or more of the ALF coefficient values; and
provide the scaled ALF coefficient values to a decoder, wherein providing the scaled ALF coefficient values to the decoder comprises encoding the scaled ALF coefficient values in a bitstream and conveying the bitstream over a network,
wherein the determined ALF coefficient values reduce an error between reconstructed image components and original image components and wherein the determined scaling factor improves subjective performance for image to be encoded.

16. A method performed by a decoder for decoding an image, the method comprising:
receiving scaled adaptive loop filter (ALF) coefficient values signaled by an encoder;
reconstructing image components; and
filtering the image components by applying the scaled ALF coefficient values to generate final reconstructed image components.

17. An apparatus (204) adapted to:
receive scaled adaptive loop filter (ALF) coefficient values signaled by an encoder;
reconstruct image components; and
filter the image components by applying the scaled ALF coefficient values to generate final reconstructed image components,
wherein the apparatus comprises a loop filter,
wherein a portion of the loop filter is adapted to perform adaptive loop filtering in which the image components are reconstructed, and the scaled ALF coefficient values are applied.

18-20. (canceled)
